(19) United States
(12) Patent Application Publication
(10) Pub. No.: US 2004/0226299 A1
(43) Pub. Date: Nov. 18, 2004

(54) Method of reducing NOX emissions of a gas turbine

(76) Inventor: Raymond Francis Drnevich, Clarence Center, NY (US)

Correspondence Address: PRAXAIR, INC., LAW DEPARTMENT - M1 557, 39 OLD RIDGEBURY ROAD, DANBURY, CT, 06810-5113, US

(21) Appl. No.: 10/435,204

(22) Filed: May 12, 2003

(51) Int. Cl. F02C 3/22

(52) U.S. Cl. 60/772; 60/39.465

(57) ABSTRACT

A method of reducing NOx emissions of gas turbines in which supplementary compressed air streams are introduced into compressors of the gas turbine. The supplementary compressed air streams have a pressure higher than that of compressor air being used to support combustion within the combustor to enhance mixing of the compressed air streams with gaseous fuel and the compressor air. The compressed air stream and the supplementary compressed air streams are introduced into the combustors at a rate greater than that required to support combustion of the gaseous fuel to thereby lower flame temperature of the combustion and therefore the NOx emissions that would be otherwise produced by the combustion. A hydrogen containing stream can be introduced into the combustors along with the fuel to enhance flame stability of the combustion.

### FIELD OF THE INVENTION

The present invention relates to a method of reducing NOx emissions of a gas turbine in which supplementary compressed air streams are introduced into combustors of the gas turbine to lower flame temperature and hydrogen is introduced into the combustors for flame stability at the lower flame temperature.

### BACKGROUND OF THE INVENTION

There is a worldwide interest in reducing gas turbine emissions, particularly NOx. Gas turbine NOx emissions are formed by the oxidation of free nitrogen in the air or bound nitrogen in fuel. There have been three major approaches to lowering flame temperature. In one approach, steam or nitrogen is added into the primary combustion zone of a gas turbine combustor through nozzles. In another approach, the gas turbine combustor system is redesigned to incorporate special mixing zones to improve flame stability at lean fuel ratios in the primary combustion zone. The third major approach is the use of what is referred to as a selective catalytic reduction unit which is added to the gas turbine exhaust to reduce NOx using ammonia or urea as a reducing agent.

The principle behind reduction of gas turbine NOx emissions involving steam or nitrogen injection or the use of lean fuel ratios is to lower combustion flame temperature to in turn lower the degree to which nitrogen will be oxidized during combustion. These methods of NOx reduction are set forth in some detail in “Gas Turbine Emissions and Control”, Pavri et al., G. E. Power Systems (2001).

In most cases, steam is used for NOx control when a heat recovery steam generator is used to recover energy from the gases leaving the gas turbine. For each pound of steam added to the primary combustion zone, approximately 1,000 BTU's of energy are utilized in vaporizing the water. When boiler inefficiencies in sensible heat losses are included in the calculation, more than 1,400 BTU's of fuel is effectively utilized in generating each pound of steam injected into the gas turbine.

In lean premix combustor designs the size and location of slots and holes in a combustion liner are specially designed to control airflow to the primary combustion zone. This passive control approach depends on the discharge pressure of the gas turbine. At a constant compressor discharge pressure, the airflow is fixed. Significant variations in fuel composition or even significant changes in the desired output of the gas turbine result in combustion instabilities. Complex fuel injection and fuel flow control systems are needed to transition from part load to full load operation and to maintain stable operation.

A selective catalytic reduction unit is an “end of pipe” solution. NOx produced by the gas turbine is reduced in the exhaust. These devices are only practical when the gas turbine exhaust is cooled to the effective reduction temperature, generally in a heat recovery steam generator. If no heat recovery steam generator is present, then the cost of implementing such a unit is prohibitive. Even if there is a heat recovery steam generator in use, there are significant capital and operating cost penalties associated with retrofitting existing systems. As may be appreciated, combinations of selective catalytic reduction units with steam addition or lean premix combustion systems are a very high cost option.

As will be discussed, the present invention provides a method of reducing NOx emissions in gas turbines that is far simpler and less expensive than options that have heretofore been used in the prior art.

### SUMMARY OF THE INVENTION

The present invention provides a method of reducing NOx emissions of a gas turbine. In accordance with the method supplementary compressed air streams are introduced into combustors of the gas turbine. The combustors are operatively associated with compressor and expander sections of the gas turbine to burn a gaseous fuel by combustion supported by compressor air produced by the compressor section to generate hot combustion gases that drive the expander section. The supplementary compressed air streams have a pressure higher than that of the compressor air to enhance mixing thereof with the gaseous fuel and the compressor air in the combustor. The compressor air and the supplementary compressed air streams are introduced into the primary combustion zone of the combustors at a rate in excess of that required to support combustion of the gaseous fuel, thereby lowering the temperature of the combustion and therefore the NOx emissions that would otherwise be produced by the combustion.

Hydrogen from a hydrogen containing stream comprising the hydrogen can be introduced into the combustors to enhance the stability of the combustion.

The use of air is better than the use of steam because of the high energy losses associated with the heat-of-vaporization associated with the steam production. As mentioned above, 1,400 BTU's of fuel are effective lost for each pound of steam injected into the gas turbine. In contrast, the sensible heat loss from air in the exhaust amounts to less than about 60 Btu's per pound of air. The difference in these losses is more than sufficient to overcome the energy required to compress the air to the pressured required for injection into the gas turbine. The use of air has a further advantage in that the availability of free oxygen in the air permits stable combustor operations at much lower temperatures in the primary combustion zone.

The invention, as outlined above also has advantages over lean premixed combustor designs, in that the flow rate of the supplementary air stream can be actively controlled by provision of valves, compressor vanes, or a variable speed compressor to in turn optimize NOx reduction while retaining or even increasing the net power output. Net power is the total power produced by the gas turbine minus the power required to drive the supplemental compressor. As can be appreciated, providing a compressor and associated control hardware to achieve low NOx emissions in the manner outlined in the present invention constitutes a much lower capital penalty than providing a selective catalyst reduction unit.

Advantageously the fuel is introduced into combustion zones by a plurality of fuel streams and hydrogen containing streams comprising the hydrogen are mixed with the fuel streams prior to their introduction. The hydrogen can be produced by steam methane reforming or by partial oxidation or by autothermal reforming reactions. Such reactions can be used to produce the hydrogen as a synthesis gas on site.

The supplementary compressed air streams can be produced by compressing ambient air in a supplemental compressor. Alternatively, the supplementary compressed air streams can be produced by compressing an air extraction air stream composed of the compressor air that is extracted from the compressor section. As a yet further alternate, the supplementary compressed air streams can be produced by compressing ambient air in the supplemental compressor to form supplemental compressed ambient air streams. The supplemental compressed air streams are combined with an extraction air stream composed of the compressor air that is extracted from the compressor section to form a combined stream. The combined stream is then compressed in a booster compressor to form the supplementary compressed air streams.

Water can be added to the supplementary compressed air streams so that the supplementary air stream is saturated.

The combustor can be a diffusion combustor and the hydrogen can be introduced into the combustor at a ratio of between 5% and about 30% by volume of the fuel. Alternatively, the combustor can be a dry low NOx combustor. In such case a hydrogen can be introduced into the combustor at a ratio of between about 10% and about 30% by volume of the fuel.

### DETAILED DESCRIPTION OF THE DRAWINGS

While the specification concludes with claims distinctly pointing out the subject matter that applicant regards as his invention, it is believed that the invention will be better understood when taken in connection with the accompanying drawings in which:

FIG. 1 is a schematic illustration of an apparatus for carrying out a method in accordance with the present invention;

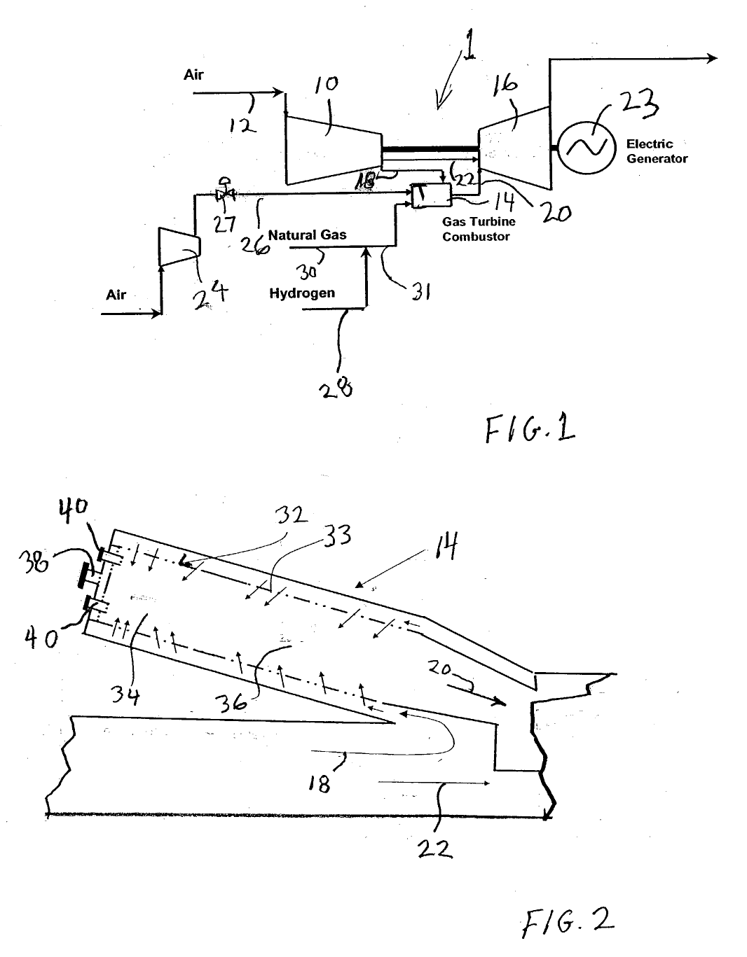

FIG. 2 is a sectional, schematic view of a gas turbine diffusion combustor utilized in carrying out a method in accordance with the present invention;

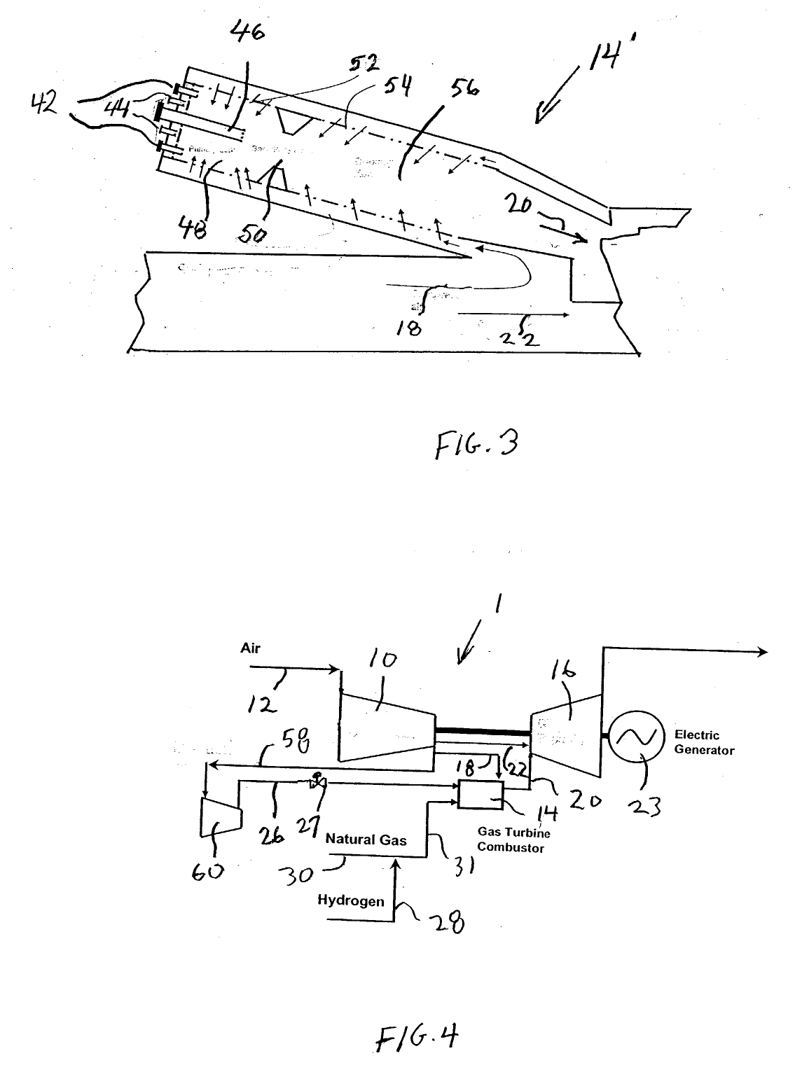

FIG. 3 is a sectional, schematic view of a gas turbine dry low NOx combustor utilized in a method in accordance with the present invention;

FIG. 4 is a schematic illustration of an alternative embodiment of an apparatus for carrying out a method in accordance with the present invention;

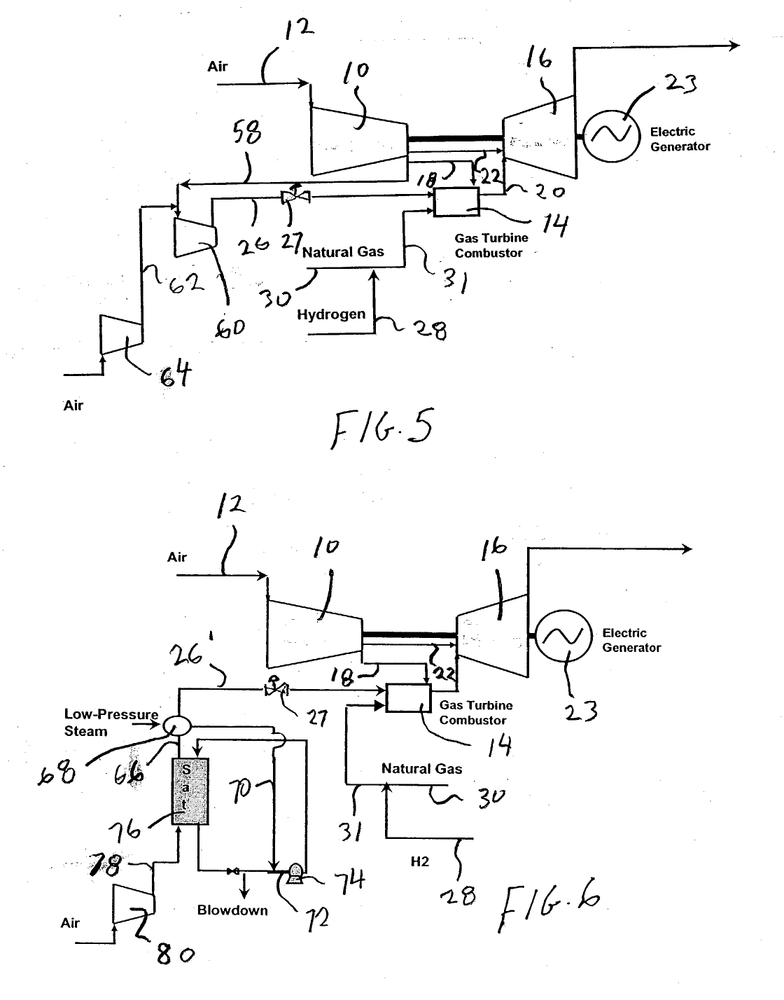

FIG. 5. is a schematic illustration of an alternative embodiment for carrying out a method in accordance with the present invention; and

FIG. 6 is a schematic illustration of yet another alternative embodiment of an apparatus for carrying out a method in accordance with the present invention.

### DETAILED DESCRIPTION

With reference to FIG. 1 a gas turbine 1 is illustrated. Gas turbine 1 includes a compressor section 10 for compressing ambient air 12, a combustor 14 and an expander section 16. Combustor 14 burns a gaseous fuel by combustion supported by compressor air contained within a compressor air stream 18 to generate hot combustion gases 20 that drive expander section 16. Expander section 16 is connected to a load 23 which in the illustration is an electric generator.

It is understood that gas turbine 1, in practice, could have anywhere from one to twenty combustors, such as combustor 14, arranged around the centerline of gas turbine 1. A small portion of the compressed air, generally less than 10% by volume, is introduced as a cooling stream 22 into gas turbine expander 16.

In order to control NOx emissions, a supplemental air compressor 24 is provided to compress air into a supplementary air stream 26 that is introduced into combustor 14 in place of steam or nitrogen to maintain or control the temperature in combustor 14.

Supplementary air stream 26 is added at the head end of combustor 14 at a pressure at least 5 psi higher than the discharge pressure of the compressor section 10 to provide sufficient energy to enhance mixing of the air with fuel. Typically, pressure within supplementary air stream 26 will be more than about 20 psi but less than about 100 psi higher than the discharge pressure of gas turbine compressor 10 to ensure sufficient mixing.

Since air can participate in the combustion reactions, the use of supplementary air stream 26 alone has the potential for extending the region of stable flame operation relative to the use of steam or nitrogen and, therefore will facilitate operating the combustor 14 at lower temperatures than is available by the alternatives. Steam addition has the potential of reducing NOx to 20 ppmv in the exhaust of gas turbine 1. It is calculated that the use of supplementary air stream 26 should allow stable operations at NOx levels approaching 15 ppmv.

In order to reduce NOx emissions below 15 ppmv, combustion temperatures within combustor 14 must be further lowered while insuring flame stability. In the present invention, this is done by increasing the volume of supplementary air stream 26 and adding a hydrogen containing stream 28 to the fuel stream 30, which can be natural gas. The hydrogen containing stream 28 is combined with the natural gas stream 30 and a combined stream 31 is introduced into gas turbine combustor 14 to support combustion. It is understood that embodiments of the present invention are possible in which hydrogen containing stream 28 is separately introduced into combustor 14 from fuel stream 30.

Hydrogen for hydrogen containing stream 28 can be obtained from any variety of sources including pipelines, on-site steam-methane reformers, autothermal reformers, air or oxygen based partial oxidation units, and by-product streams. Pure hydrogen is not necessary. The hydrogen containing stream 28 can contain any number of other species as long as the composition is relatively constant. Large variations in hydrogen content, however, make the system difficult to control.

Table 1 summarizes the approximate air requirements for supplementary air stream 26 per pound of fuel needed to achieve target NOx levels for large gas turbines of a size greater than about twenty megawatts. For purposes of Table 1, the temperature of the supplemental air is 400° F.

TABLE 1
Air Rates for Diffusion and Modified Diffusion
Combustors
(Base Fuel: Natural Gas)

| % by | | | |
|---|---|---|---|
| Volume | | | Modified |
| Hydrogen | | Diffusion | Diffusion |
| in | Gas Turbine | Combustor | Combustor |
| Natural | NOx | Lbs./ air/lb. | Lbs. Air/Lb. |
| Gas | ppmv | Fuel | Fuel |
| 0 | <˜25 | ˜3.5 | ˜0.5 |
| ˜10% | <˜10 | ˜5 | ˜1.5 |
| >20% | <˜5 | ˜6.5 | ˜3 |

In Table 1, the diffusion combustor is essentially the basic combustor offered by most turbine manufacturers. The modified diffusion combustor represents a known design referred to as a lean head end combustor that incorporates a special lean head end combustion liner to increase the airflow to the primary combustion zone to the limit of stable combustor operation with natural gas. Although not set forth in Table 1, dry low NOx combustors are capable of functioning with NOx emissions that are less than about 10 ppmv. Emission of such combustors using a method in accordance with the present invention can be reduced to about 3 ppmv with about 10 percent by volume of hydrogen within the natural gas and about 2.5 pounds of air per pound of fuel introduced as supplementary air stream 26.

As illustrated in Table 1, hydrogen within hydrogen containing stream 28 is added to natural gas contained within fuel stream 30 at a sufficient rate to insure flame stability for a given level of supplemental air addition by way of supplementary air stream 26 and NOx emissions. The fuel, hydrogen and supplemental airflow combination will depend on gas turbine combustor design and the level of NOx emission control required. It is to be noted, however, that in case of diffusion combustors, hydrogen addition of less than about 5% by volume with respect to the fuel will in most cases not be effective and hydrogen additions greater than 30% will be prohibitively expensive. In case of dry low NOx combustors the lower effective limit for the effective amount of hydrogen is about 10% by volume of the fuel.

The flow of supplemental air stream 26 is controlled through the use of control valves and/or guide vanes and/or speed control in the supplemental air compressor 24. The flow control is shown for illustration purposes as a valve 27. The control system can be integrated with the basic gas turbine control logic of gas turbine 1. In this regard, although not specifically illustrated, the metering of combined stream 31 would be controlled by known fuel controls of gas turbine 1.

During full load and during part load operations down to a range of 80% to 90% of the full load, supplementary air stream 26 will be supplied at a flow rate that is proportional to the fuel flow rate and at specific ratios, for instance, the ratios indicated in Table 1. It is to be noted, however, that the ratios of Table 1 are based on calculation and such ratios can change given the size and operating conditions of the compressor installation. At part load operations less than about 80% to about 90% full load, the flow of supplemental air stream 26 will be reduced relative to fuel flow to insure flame stability without a significant increase in NOx emissions. The exact proportions of air and fuel at such point will vary with the particular gas turbine and combustor configuration used in gas turbine 1 and would have to be determined by actual practice. At very low loads, less than about 50% of full load and during startup, little or no supplementary air by way of supplementary air stream 26 will be added to the combustor 14.

Table 1 illustrates the case in which the flow of hydrogen containing stream 28 is zero or not provided. Typical calculated NOx emissions in such case will be less than about 25 ppmv. As indicated above, less than 15 ppmv with supplemental air addition alone are possible. The reason for showing the results of such calculation is that an additional benefit of the introduction of supplementary air stream 26 into combustor 14 is that it increases gas turbine output over operation with natural gas alone. The additional mass brought into gas turbine 1 by the active air control provided by supplementary air stream 26 will more than offset the power consumed by the supplemental compressor 24. Hence, the present invention covers the situation in which supplementary air stream 26 is used without any addition of hydrogen to the fuel stream.

It is to be noted that the foregoing statements with respect to the use of supplementary air stream 26 alone will pertain to the operation of gas turbine 1 except at low ambient temperatures, less than about 30° F., when the gas turbine is located near sea level.

With reference to FIG. 2, combustor 14 is a diffusion type combustor having a combustion liner 32 to direct the flow of air (indicated by the unlabelled arrowheads) to various locations to provide air for combustion as well as air to reduce the temperature of the products of combustion to the allowable turbine inlet temperature. The sizing and directional orientation of the holes and slots 33 in the liner are specifically sized to distribute the air as required to meet the combustion and cooling requirements. In this regard, depending on the gas turbine design this maximum turbine inlet temperature can range from between about 1,700° F. and about 2,600° F. Combustion takes place within a combustion zone 34 and cooling occurs within a cooling zone 36. A central air nozzle 38 is provided for introduction of supplementary air stream 26 into the primary combustion zone 34. Combined stream 31 is injected into the primary combustion zone 34 by way of fuel nozzles 40 that in practice would surround fuel nozzle 38. In a retrofit situation, central air nozzle 38 could be provided through appropriate modifications of a known central nozzle used for steam injection. Alternative head end configurations are anticipated.

With reference to FIG. 3, a combustor 14′ could be used in place of combustor 14. Combustor 14′ is a dry low NOx combustor modified in accordance with the present invention. Combustor 14′ is provided with primary fuel nozzles 42 for introduction of combined stream 31 and air nozzles 44 for introduction of supplementary air stream 26. In addition, a secondary fuel nozzle 46 is provided. Generally such dry low NOx combustors operate with a maximum amount of airflow into a primary combustion zone 48. At full flow, minimum NOx is achieved by using primary combustion zone 48 as a mixing chamber to ensure that a uniform mixture of fuel and air enters the secondary combustion zone 50. Secondary fuel nozzle 46 acts as a pilot to insure combustion stability. It is to be noted that a combustion liner 52 is provided having slots and holes to direct air (indicated by the unlabelled arrowheads) in primary combustion zone 48, secondary combustion zone 50 and also a cooling zone 56 serving the same purpose as cooling zone 36 for combustor 14 illustrated in FIG. 2.

With reference to FIG. 4, in an alternative embodiment, an extraction air stream 58 from compressor 10 is introduced into a booster compressor 60 to produce supplementary air stream 26. A heat exchanger can be provided to exchange heat between extraction air stream 58 and the compressor air stream 18 along with some cooling on the inlet of the booster compressor 60 to facilitate the use of readily available compressor units that are designed to operate at temperatures of no more than about 600° F. The use of booster compressor 60 has a negative impact on the overall power from the system, the gas turbine power minus that expended in operating the booster compressor 60 will be less than the original gas turbine power.

With reference to FIG. 5, extraction air stream 58 along with a supplemental air stream 62, compressed in a supplemental air compressor 64, is compressed in booster compressor 60 to produce supplementary air stream 26. This approach uses booster compressor 60 as the last stage of supplemental compressor 64.

With reference to FIG. 6, yet another approach, low level steam is used to reduce the amount of supplemental air needed. Low pressure steam is heat exchanged against a saturated air stream 66 in a heat exchanger 68. This superheats saturated air stream 66 to form a supplementary air stream 26′ for injection into combustor 14. The low pressure steam in stream 70 leaving heat exchanger 68 will be near saturated steam conditions. Saturated air stream 66 is formed by mixing stream 70 with a recirculation hot water stream 72 which is recirculated by a pump 74. Recirculated stream 72 is introduced into a saturator 76 to saturate a compressed supplementary air stream 78 compressed by supplemental air compressor 80.

Other sources of heat can be used to saturate the air. These include hot water from a heat recovery steam generator or other source, high pressure steam for superheating the mixture in combination with low pressure steam for delivering the heat needed to saturate the air. In addition, if a non-inter-cooled or partially non-inter-cooled supplemental compressor is used, the hot air exiting the compressor can be used to superheat the saturated air by indirect heat exchange with the saturated air. The cooler compressed air from the heat exchanger used for such purpose would then be introduced into the bottom of the saturator for moisturizing. An additional source of heat would be needed to obtain a significant level of moisturization in the compressed air. It is also possible to moisturize the fuel as well as the air. In this situation, a separate moisturization system would be needed for the fuel stream.

As will occur to those skilled in the art, numerous changes, additions and omissions may be made without departing from the spirit and the scope of the present invention.

I claim:

1. A method of reducing NOx emissions of a gas turbine, said method comprising:
introducing supplementary compressed air streams into combustors of said gas turbine, the combustors operatively associated with compressor and expander sections of said gas turbine to burn a gaseous fuel by combustion supported by compressor air produced by said compressor section and thereby to generate hot combustion gases to drive said expander section;
the supplementary compressed air streams having a pressure higher than that of said compressor air to enhance mixing thereof with said gaseous fuel and said compressor air and the supplementary compressed air streams being introduced into said combustors at a rate in excess of that required to support the combustion of the gaseous fuel, thereby to lower flame temperature of said combustion and therefore the NOx emissions that would otherwise be produced by said combustion.

2. The method of claim 1, wherein hydrogen from a hydrogen containing stream comprising the hydrogen is introduced into said combustors to enhance flame stability of said combustion.

3. The method of claim 1, wherein:
said fuel is introduced into combustors by a plurality of fuel streams; and
said hydrogen containing streams comprising said hydrogen are mixed with said fuel streams.

4. The method of claim 3, wherein said hydrogen is produced by stream methane reforming or by partial oxidation or by autothermal reforming reactions.

5. The method of claim 1, wherein said supplementary compressed air streams are produced by compressing ambient air in a supplemental compressor.

6. The method of claim 1, wherein said supplementary compressed air streams are produced by compressing an extraction air stream composed of said compressor air that is extracted from said compressor section.

7. The method of claim 1, wherein said supplementary compressed air streams are produced by:
compressing ambient air in a supplemental compressor to form a supplemental compressed ambient air streams;
said supplemental compressed ambient air stream is combined with an extraction air stream composed of said compressor air that is extracted from said compressor section to form a combined stream; and
said combined stream is compressed in a booster compressor to form said supplementary compressed air streams.

8. The method of claim 5, further comprising adding water to said supplementary air stream so that said supplementary air stream is saturated.

9. The method of claim 2, wherein:
said combustor is a diffusion combustor; and
said hydrogen is introduced into said combustor at a ratio of between about 5 percent and about 30 percent by volume of said fuel.

10. The method of claim 2, wherein:
said combustor is a dry low NOx combustor; and
said hydrogen is introduced into said combustor at a ratio of between about 10 percent and about 30 percent by volume of said fuel.
